(19) United States
(12) Patent Application Publication
(10) Pub. No.: US 2012/0044876 A1
(43) Pub. Date: Feb. 23, 2012

(54) METHOD AND APPARATUS FOR VIRTUALIZATION OF WIRELESS NETWORK

(76) Inventor: Pouya TAAGHOL, San Jose, CA (US)

(21) Appl. No.: 12/858,684

(22) Filed: Aug. 18, 2010

(51) Int. Cl. H04W 8/00

(52) U.S. Cl. 370/329

(57) ABSTRACT

A method, apparatus and a system to share a wireless spectrum by mobile devices of different operators. The sharing of the wireless spectrum is done by providing a first virtual base station to communicate with mobile devices of a first operator and providing a second virtual base station to communicate with mobile devices of a second operator.

### BACKGROUND OF THE INVENTION

Mobile Cellular Operators have traditionally acquired expensive spectrum licenses and have deployed their own Radio Access Network (RAN) and Core Networks (CN). New network deployments take a long time and require large capital expenditures.

In some countries the coverage offered by different operators are fairly similar as far as the users are concerned. RAN basically allocates a predetermined spectrum bandwidth for data and the operator's differentiations may be on the services offered on top of these allocated spectrum bandwidth to the end user.

The demand for wireless broadband and mobile Internet will further fuel deployment of the next generation RANs, 4^{th} Generation (4G). Emerging 4G broadband technologies, such as, for example WiMAX and/or long term evolution (LTE) radio systems, may require large chunks of frequencies spectrum. The useful and globally available frequency spectrums for 4G are limited and scarce in most countries. Furthermore, auctions for these spectrums may result in even smaller frequency spectrum pieces for each operator. Thus, a more efficient use of the frequency system is needed.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is an illustration of a wireless communication system according to some exemplary embodiments of the present invention;

FIG. 2 is an illustration of a protocol flow between components of a wireless communication system according to some exemplary embodiments of the present invention;

FIG. 3 is a flowchart depicting a method of sharing a wireless spectrum by a plurality of mobile devices of different operators according to exemplary embodiment of the invention; and

FIG. 4 is an illustration of a block diagram of a base station according to exemplary embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However it will be understood by those of ordinary skill in the art that the present invention may be practiced without these specific details. In other instances, well-known methods, procedures, components and circuits have not been described in detail so as not to obscure the present invention.

Some portions of the detailed description, which follow, are presented in terms of algorithms and symbolic representations of operations on data bits or binary digital signals. These algorithmic descriptions and representations may be the techniques used by those skilled in the signal processing arts or/and in wireless communication arts to convey the substance of their work to others skilled in the art.

Unless specifically stated otherwise, as apparent from the following discussions, it is appreciated that throughout the specification discussions utilizing terms such as “processing,” “computing,” “calculating,” “determining,” or the like, refer to the action and/or processes of a computer and/or computing system and/or medium access controller (MAC) and/or communication processor, or similar electronic computing device, that manipulates and/or transforms data represented as physical, such as electronic, quantities within the computing system's registers and/or memories into other data similarly represented as physical quantities within the computing system's memories, registers or other such information storage, transmission or the like. In addition, the term “plurality” may be used throughout the specification to describe two or more components, devices, elements, parameters and the like. For example, “plurality of mobile stations” describes two or more mobile stations.

It should be understood that embodiments of the present invention may be used in a variety of applications. Although the present invention is not limited in this respect, the circuits and techniques disclosed herein may be used in many apparatuses such as communication devices of a radio system. The communication devices intended to be included within the scope of the present invention include, by way of example only, mobile stations, base stations and access points of radio systems such as, for example wireless local area network (WLAN) which also may be referred as WiFi, wireless metropolitan area network (WMAN) which also may be referred as WiMAX, a wireless personal area network (WPAN) such as, for example using Bluetooth™ protocols, two-way radio transmitters, digital system transmitters, analog system transmitters, cellular radiotelephone transmitters, digital subscriber lines, LTE cellular systems and the like.

Some embodiments of the invention may be implemented, for example, using a machine-readable medium or article which may store an instruction or a set of instructions that, when executed by a processor or machine, cause the processor or machine to perform a method and/or operations in accordance with embodiments of the invention. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit or the like. The instructions may include any suitable type of code, for example, source code, compiled code, interpreted code, executable code, static code, dynamic code, or the like, and may be implemented using any suitable high-level, low-level, object-oriented, visual, compiled and/or interpreted programming language, e.g., C, C++, Java, assembly language, machine code, or the like.

In accordance with embodiments of the invention, a channel may be a physical transfer medium. The physical transfer medium may be used to transfer signals such as, for example, informative data signals, training signals, pilot signals, sub-carriers signals, preamble signals and the like, that may be modulated by one or more modulation scheme. Furthermore, the channel may be a combination of the physical transfer medium, components of the transmitter and/or the receiver, for example path loss, noise, interference or the like. It should be understood to the skilled artisan that embodiments of the invention may operate with many types of signals, which partially mention above, and the invention is in no way limited to the above mentioned signals.

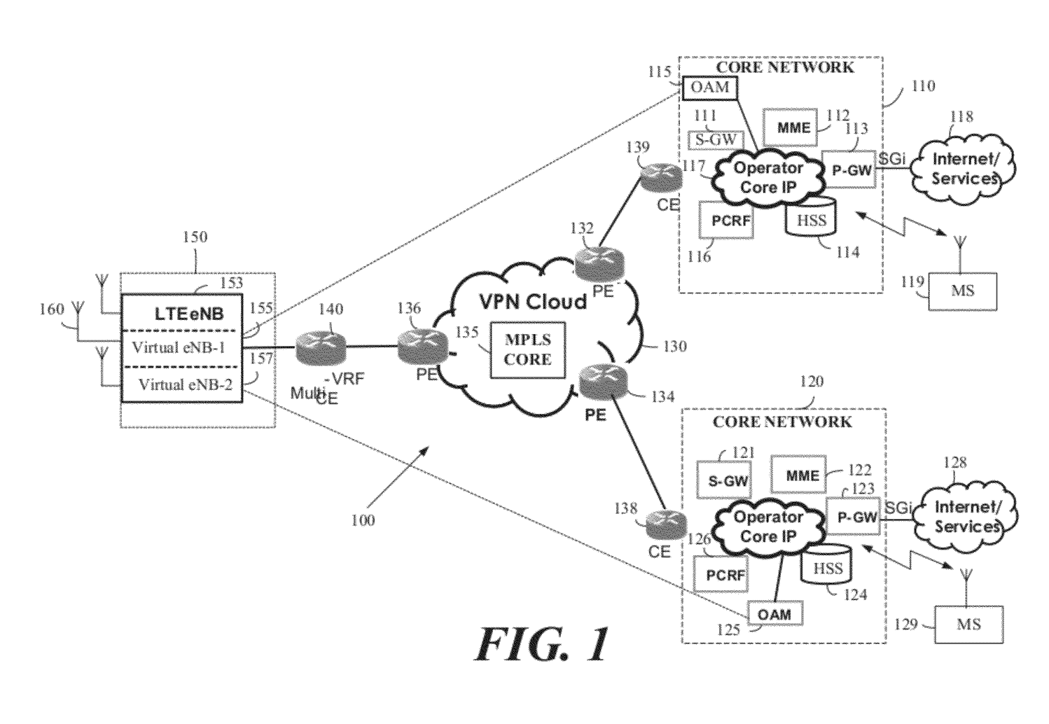

Turning first to FIG. 1, an illustration of a wireless communication system 100 according to some exemplary embodiments of the present invention is shown. Wireless communication system 100 may include, but not limited to, a first core network 110 operated by a first operator 110 or service provider, a second core network 120 operated by a second operator 120 or service provider, a Virtual Private Network (VPN) cloud 130, a multi-Virtual Routing & Forwarding (VRF) Customer Edge (CE) 140 and a base station 150. With embodiments of the present invention, an operator may be, for example, an organization or company associated with or operating a network, including equipment.

According to one exemplary embodiment of the invention core network 110 may include, but is not limited to, a servicing gateway (S-GW) 111, a Mobility Management Entity (MME) 112, a Packet Gateway (P-GW) 113, a Home Subscriber Server (HSS) 114, Operations, Administration, Management (OAM) 115, a Policy Charging Rules Function (PCRF) 116, an operator core network cloud 117 and an Internet and/or other services 118. Core network 120 may includes, but not limited to, an S-GW 121, a MME 122, a P-GW 123, a HSS 124, an OAM 125, a PCRF 126 and an Internet and/or other services 128.

According to this example, core network 110 may be operably coupled to VPN cloud 130 via a Client Edge (CE) 138 and a Provider Edge (PE) 134. Core network 120 may be operably coupled to VPN cloud 130 via a CE 138 and a PE 132.

According to one example embodiment of the invention, wireless communication system 100 includes a Long Term Evolution (LTE) cellular system and Evolved Packet Core (EPC). According to this example, VPN cloud 130 may include a Multi-Protocol Label Switching (MPLS) core 135. According to embodiments of the invention, MPLS 135 is a mechanism which may be used in 4G cellular communication systems such as, for example LTE and WiMAX in order to direct and carry data from one network node (e.g., CE 139 and PE 134, CE 138 and PE 132) to the next network node for example PE 136. MPLS 135 mechanism may be used to create virtual links between distant wireless communication system 100 nodes. For example, MPLS mechanism 135 of VPN cloud 130 may create virtual links between core networks 110 and 120 to base station 150 via multiple virtual routing and forwarding (VRF) CE 140, although it should be understood that the scope of the present invention is not limited to this exemplary embodiment of the invention.

Base station 150 may include an eNB of LTE cellular system 153. eNB may be defined as Evolved Node B. The eNB is a complex base station that handles radio communications with multiple devices in the cell and may carry out radio resource management and handover decisions. Base station 150 may include a virtual eNB 153 to be used with core network 110 and a virtual eNB 157 to be used with core network 120, although the scope of the present invention is not limited in this respect.

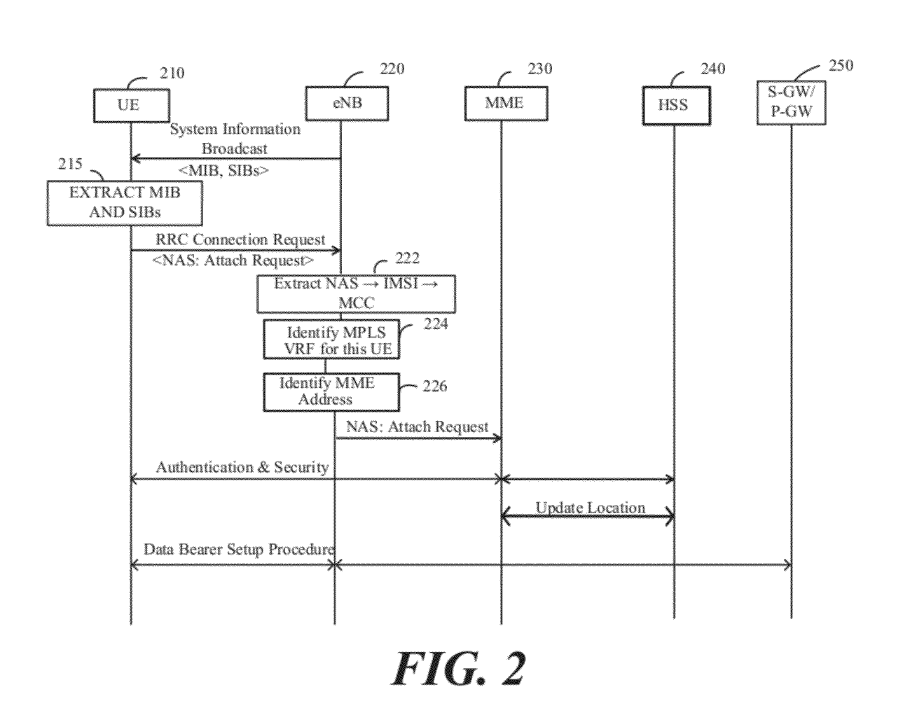

Turning to FIG. 2, an illustration of a protocol flow between components of a wireless communication system according to an embodiment of the present invention is shown. In the embodiment shown, the protocol flow includes the flow of protocol commands for sharing Radio Access Network (RAN) generated by a base station (BS) virtualization for example eNB 220. BS virtualization enables a BS (e.g. eNB 220) to operate two or more instantiation of BSs logically in a single physical BS (e.g., BS 150). Each virtualized instantiation may represent or be associated with an operator such that the subscribers of those operators may not see any difference between a virtualized BS and/or a non-virtualized BS. The flow of the protocol commands may be between a mobile station, for example User Equipment (UE) 210, and a base station, for example eNB 220 that may include for example, BS 150. According to one exemplary embodiment of the invention, an MME 230, a HSS 240 and S-GW/P-GW 250 may be used for establishing the base station virtualization connections.

According to this exemplary embodiment, eNB 220 may broadcast system information by transmitting for example, a master information block (MIB) and plurality of system information blocks (SIBs) to UE 210. In one example of an LTE system, the MIB may include information about a cell bandwidth, PHICH (Physical HARQ Indicator Channel) and the system frame number (SFN), number of transmit antennas and the like. The MIB may be scrambled with a cell-id, if desired. The SIBs may carry in the PDSCH, whose information is obtained from the PDCCH indicated by the control format indicator (CFI) field.

UE 210 may extract the MIB and the SIB (text block 215) and may send a radio resource control (RRC) connection request to the base station (e.g., eNB 220). For example, the RRC connection request may include a Non-Access Stratum (NAS) request.

According an embodiment of the invention NAS is a functional layer in the UMTS protocol stack between Core Network (CN) and the UE. The layer supports signaling and traffic between the CN of each operator to the UE of each operator, respectively.

Although the scope of the present invention is not limited to this exemplary embodiment, eNB 220 may extract from the NAS request a mobile country code (MCC) and an International Mobile Subscriber Identity (IMSI). eNB 220 may identify MPLS Virtual Routing & Forwarding (VRF) for UE 210 (text block 224) and may identify a network manger address for example, an MME address (text block 226). In the next protocol step, eNB 220 may send NAS request to a network manager for example, MME 230. MME 230 may control authentication and security on the data flow between UE 210 and HSS 240 may update a location of UE 210 at HSS 240. Finally, eNB 220 may provide a data bearer procedure to UE 210 to provide service via S-GW and P-GW 250, although the scope of the present invention is not limited in this respect.

Embodiments of the present invention may share RAN infrastructure by eNB virtualization, if desired. For example, the association between the Service Provider and Radio Access Network (RAN) operator may become virtual. The traffic and signaling routing may be achieved by various Virtual Private Network (VPN) technologies such as, for example MPLS, L2TP, IPSec, and the like.

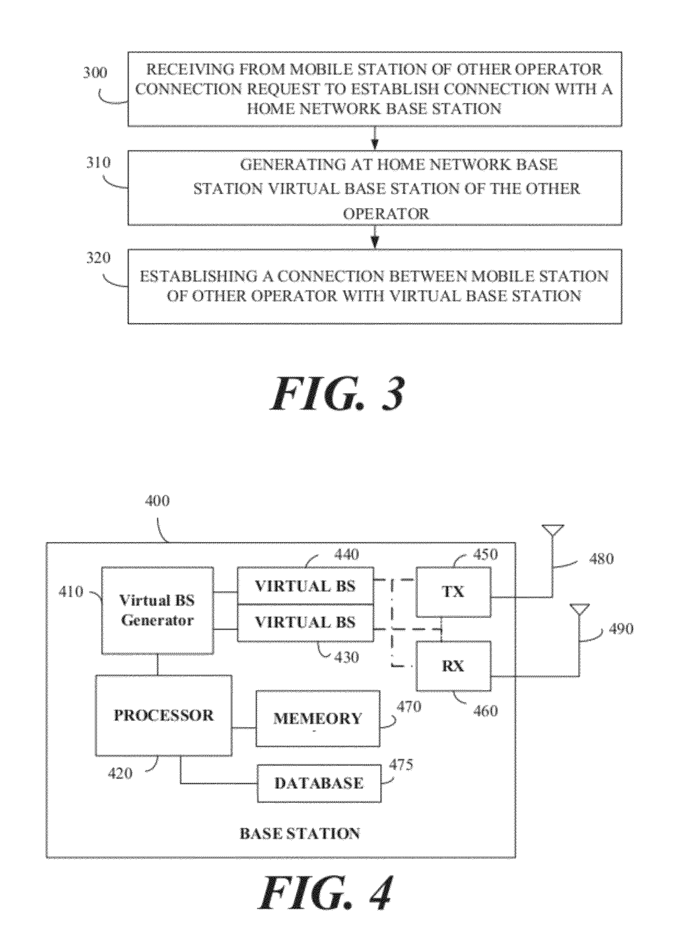

Turning to FIG. 3 a flow chart depicting a method of sharing a wireless spectrum by a plurality of mobile devices of different operators according to exemplary embodiment of the invention is shown. According to this embodiment, a home network base station (e.g. eNB 150) may receive from a mobile station (e.g., MS 119) of another operator (e.g., CN 110) a connection request to establish a connection with the home network base station (text block 300). For example, the message may be, or includes, an NAS request. The NAS request may include a mobile country code, a mobile network code and a mobile subscriber identification (ID) code, if desire. When used herein, “of” an operator or service provider may mean that equipment or service is associated with, controlled by or operated by an operator. E.g., a cellular service operator may provide service via base stations to mobile devices.

After, or in response to receiving the connection request, the home network base station may identify a home network of the requesting mobile station based on the mobile country code, the mobile network code and the mobile subscriber identification (ID) code and may generate a virtual base station (e.g. virtual eNB-1 155 and virtual eNB-2 157) of the other operator at the home network base station (text box 310). At this stage, a connection between the mobile station and the virtual base station may be established (text box 320). In some embodiments of the invention the connection may be established by identifying a network manager address (e.g., MME address) and sending the connection request to a network manager (e.g., MME 230), if desired.

Furthermore, station temporary and permanent identities such as, for example mobile country code, the mobile network code and the mobile subscriber identification (ID) code may be linked to a corresponding virtual base station context database, although the scope of the present invention is not limited in this respect.

Turning to FIG. 4 an illustration of a block diagram of a base station 400 according to exemplary embodiments of the invention is shown. Base station 400 may include a virtual base station (BS) generator 410 which may generate a virtual BS 430 and a virtual BS 440. Virtual BSs 430 and 440 may be connected to a transmitter (TX) 450 and a receiver (RX) 460 (shown with the dotted lines). It should be understood that TX 450 and RX 460 may be use both by the physical BS 400 and the virtual base stations 430 and 440.

Furthermore, BS 400 may include a processor 420, a memory 470, a database 475 and antennas 480 and 490. For example, processor 420 may control virtual BS generator 460 and to that end may use or execute a software application, instructions and data that may be stored in memory 470 and database 475, although the scope of the present invention is not limited in this respect.

According to embodiment of the invention, antennas 480 and 490 may be any antenna that is used for wireless communication. For example, dipole antennas, antenna arrays and the like. Memory 470 and database 475 may be any storage medium used with base stations for example, hard disk, flash memories and the like. Processor 420 may be and/or includes, for example, a medium access controller (MAC), a physical layer (PHY) controller, a digital signal processor (DSP) and the like.

According to one exemplary embodiment of the invention, BS 400 may be a home network base station and may receive by antenna 490 and RX 460 a connection request from a mobile station of another operator and/or another network in order to establish a connection with BS 400. The connection request may include a message that includes temporary and permanent identities of the mobile station such as, for example a mobile country code, a mobile network code and mobile subscriber identification (ID) code and other parameters, if desired. The temporary and permanent identities of the mobile station may be linked to corresponding virtual base station context database for example database 475 which may be use by each and both virtual base stations 430 and 44o, if desired.

Processor 420 may identify a home network of said mobile station based on the mobile country code, the mobile network code and the mobile subscriber identification (ID) code. Processor 420 may identify a network manager address and may send a connection request to a network manager (e.g., MME 230). Processor 420 may command virtual BS generator 410 to generate at the home BS (e.g., BS 400) a virtual BS, for example virtual BS 440, which may simulate a home BS of the mobile station home network, if desired. Virtual BS 440 may be operably connected to TX 450 and RX 460 in order to establish a connection between the mobile station and virtual BS 440, although the scope of the present invention is not limited to this example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of sharing a wireless spectrum by a plurality of mobile devices of different core networks, the method comprising:
generating at a base station of a first core network operated by a first operator a virtual base station of a second core networks operated by a second operator; and
establishing a connection between a mobile station of the second core network with the virtual base station of the first core network.

2. The method of claim 1, wherein generating comprises:
receiving from said mobile station a connection request to establish a connection with a home network base station;
generating a virtual home network base station of said mobile station; and
establishing a connection with the virtual home base station of said mobile station.

3. The method of claim 2, wherein receiving comprises:
receiving a message that includes a mobile country code, a mobile network code and a mobile subscriber identification (ID) code; and
identifying a home network of said mobile station based on the mobile country code, the mobile network code and the mobile subscriber identification (ID) code.

4. The method of claim 3, comprising:
identifying a network manager address; and
sending the connection request to the network manager.

5. The method of claim 4, comprising:
establishing a connection based on the connection request; and
linking temporary and permanent identities of the mobile station to a corresponding virtual base station context database.

6. A base station of wireless communication system for sharing a wireless spectrum by a plurality of mobile devices of different operators, the base station comprising:
a first virtual base station of a first operator; and
a second virtual base station of a second operator, wherein the base station is able to establish a connection between a first mobile station of a first operator with the first virtual base station and to establish a connection between the second virtual base station and a second mobile station of the second operator.

7. The base station of claim 6, comprising:
a receiver to receive from at least one of the first or second mobile stations a connection request with a home network base station; and
a virtual base station generator to generate a virtual home network base station according to the connection request.

8. The base station of claim 7, comprising:
a processor to identify a home network of said first or second mobile station according to the mobile country code the mobile network code and the mobile based on a message received from the first or the second mobile station, wherein the message includes a mobile country code, a mobile network code and a mobile subscriber identification (ID) code and to subscriber identification (ID) code.

9. The base station of claim 8, wherein the processor is able to identify a network manager address and to send the connection request to the network manager.

10. The base station of claim 8, wherein the processor is able to establish a connection between the first mobile station and the first virtual base station and to establish a connection between the second mobile station and the second virtual base station, and to link mobile station temporary and permanent identities to a corresponding virtual base station context database.

11. A wireless communication system comprising:
a base station for sharing a wireless spectrum by a plurality of mobile devices of different operators, the base station comprising:
a first virtual base station of a first operator; and
a second virtual base station of a second operator wherein the base station is able to establish a connection between a first mobile station of a first operator with the first virtual base station and to establish a connection between the second virtual base station and a second mobile station of the second operator.

12. The wireless communication system of claim 11, comprising:
a receiver to receive from at least one of the first or second mobile stations a connection request with a home network base station; and
a virtual base station generator to generate a virtual home network base station according to the connection request.

13. The wireless communication system of claim 12, wherein the receiver is able to receive a message from the first or the second mobile station that includes a mobile country code, a mobile network code and a mobile subscriber identification (ID) code and to identify a home network of said first or second mobile station according to the mobile country code the mobile network code and the mobile subscriber identification (ID) code.

14. The wireless communication system of claim 12, wherein the base station is able to identify a network manager address and to send the connection request to the network manager.

15. The wireless communication system of claim 12, wherein the base station is able to establish a connection between the first and second mobile station and the first and second virtual base stations, respectively, and to link mobile station temporary and permanent identities to a corresponding virtual base station context database.

16. A base station of wireless communication system for sharing a wireless spectrum by a plurality of mobile devices of different operators, the base station comprising:
a first virtual base station of a first operator;
a second virtual base station of a second operator wherein the base station is able to establish a connection between a first mobile station of a first operator with the first virtual base station and to establish a connection between the second virtual base station and a second mobile station of the second operator; and
two or more dipole antennas operably coupled to the base station for transmitting and receiving signals to and from the plurality of mobile stations of different operators.

17. The base station of claim 16, comprising:
a receiver to receive from at least one of the first or second mobile stations a connection request with a home network base station; and
a virtual base station generator to generate a virtual home network base station according to the connection request.

18. The base station of claim 17, comprising:
a processor to identify a home network of said first or second mobile station according to the mobile country code the mobile network code and the mobile based on a message received from the first or the second mobile station, wherein the message includes a mobile country code, a mobile network code and a mobile subscriber identification (ID) code and to subscriber identification (ID) code.

19. The base station of claim 18 wherein the processor is able to identify a network manager address and to send the connection request to the network manager.

20. The base station of claim 18, wherein the processor is able to establish a connection between the first and second mobile station and the first and second virtual base stations, respectively, and to link mobile station temporary and permanent identities to a corresponding virtual base station context database.
